(19) United States
(12) Patent Application Publication
(10) Pub. No.: US 2004/0143490 A1
(43) Pub. Date: Jul. 22, 2004

(54) Auto storage facility

(76) Inventors: Michael D. Kelly, Marco Island, FL (US); Michael R. Kelly, Marco Island, FL (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/754,621

(22) Filed: Jan. 12, 2004

Related U.S. Application Data
(63) Continuation of application No. 09/276,473, filed on Mar. 25, 1999, now abandoned.
(60) Provisional application No. 60/079,421, filed on Mar. 26, 1998.

(51) Int. Cl. G06F 17/60

(52) U.S. Cl. 705/13

(57) ABSTRACT

An auto storage facility, parking space, and method for long term storage of vehicles.

### RELATED APPLICATION

This application is a regular application of Provisional application 60/079,421, filed Mar. 26, 1998, and claims full benefit of priority to this provisional application.

### FIELD OF THE INVENTION

The invention relates to an auto storage center and individual parking spaces therein. Optional features include in-house maintenance facilities, regular maintenance of vehicles, etc.

### DISCUSSION OF THE BACKGROUND

Americans love their cars. They keep them in garages, maintain them, clean and wax them. Cars are a point of pride in America. Even cosmetically challenged cars are referred to as “reliable transportation.”

In many instances, people worry about their cars when they will be away from them for extended periods. For example, when one travels for a month or several months at a time the long term security of one's car is an issue, as is its maintenance and upkeep. Cars left unattended for long periods of time degrade: batteries die, tires deflate, valves, gaskets and seals degrade, and parts which are designed to move stiffen. In addition, cars remaining at rest for long periods of time collect dust and dirt.

### OBJECTS OF THE INVENTION

One object of the invention is to address the problems noted above and provide a parking space and/or an auto storage and maintenance facility whereby car owners may leave their cars for extended periods of time secure in the knowledge that their car is being well taken care of and maintained.

A further object of the invention is an auto storage facility and parking space designed to accomplish the above objective.

Another object of the invention is to provide a method for storing and maintaining automobiles for extended periods of time in good operating condition, and for managing such storage and maintenance.

Another object is a computer program product for accomplishing one or more of the above objects.

### BRIEF DESCRIPTION OF THE DRAWINGS

These and other objects will become apparent upon review of the following description of the invention in conjunction with the Figures wherein:

FIG. 1 shows an exemplary portion of a generalized computer system upon which portions of the invention may be implemented; and

FIG. 2 illustrates an exemplary portion of a generalized hardware configuration, in the format of a work station, upon which a portion of the invention may be implemented.

### SUMMARY OF THE INVENTION

While the present invention is mainly directed to the storage and maintenance of automobiles (cars) the invention fully relates to the storage and maintenance of other vehicles in general, including vans, trucks, boats, motorcycles, jet-skis, etc., all of which are included in the terms “car”, “vehicle”, “auto” and “automobile.” As used herein, “long term” storage means over two weeks, including one, two, three months, etc.

In a preferred embodiment, the invention relates to a complete auto storage facility adapted for the long-term storage of automobiles. Preferably, the auto storage facility contains a plurality of spaces in which a car may be parked. If the auto storage facility has floors which are not at ground level, cars may be transported to non-ground levels via elevators, ramps, etc. Preferably, the various floors and/or spaces of the auto storage facility are temperature- and humidity-controlled such that the cars stored in the storage facility are not subject to extreme temperatures (e.g., over 100° F. or under 32° F.). Preferably, the temperature of the auto storage facility is maintained at a more temperate state, such as below 80% relative humidity and between 40 and 90° F. If desired, the spaces within the auto storage facility may contain a bin or bins for the safe storage of items other than automobiles.

Preferably, the auto storage facility is a condominium wherein each space is freely alienable. Alternatively, the auto storage facility may be a co-op (cooperative) wherein the alienability of the spaces therein is subject to approval by a Board and perhaps owners of other spaces. Time-share arrangements are also contemplated. Of course, the auto storage facility may be wholly owned, and spaces may optionally be rented out.

In a highly preferred embodiment, the auto storage facility contains therewithin, or adjacent thereto, an auto maintenance facility such as an auto care garage capable of providing services such as auto repair, cleaning and maintenance. A convenience store may also optionally be located on site or adjacent thereto. Auto services optionally provided include one or more of car detailing, car washing, and routine maintenance items such as oil changes, lube, maintenance of fluid levels (window washing fluid, brake fluid, radiator fluid, battery fluid, etc.), tire pressure, battery charge, starting and driving the car, etc.

In a highly preferred embodiment, cars stored in the invention auto storage facility will be entered into a routine maintenance software program such as that described in FIG. 3. This program will effect calculation of the date(s) on which routine maintenance services provided by the auto storage facility and selected by the owner/renter of the space are to be provided. For example, regular battery charging may take place every 30 days, tire pressure maintenance may be provided every 60 days, the car may be washed every 90 days, the car may be driven, for example for ten miles, every 30 days, etc. One of ordinary skill can determine the schedule of services; the days noted above are only examples. This program may also have entered thereinto car repair and maintenance orders from the car owner and a date on which such items are to be accomplished with a mechanism prompting the party responsible for executing the maintenance and repair items (e.g., a printed reminder, a clearable field on a computer screen, etc.) preferably in advance of the date on which the car owner will return to reclaim his auto, such date also optionally being entered into the program and useful to calculate and schedule when the repair and maintenance items should be accomplished.

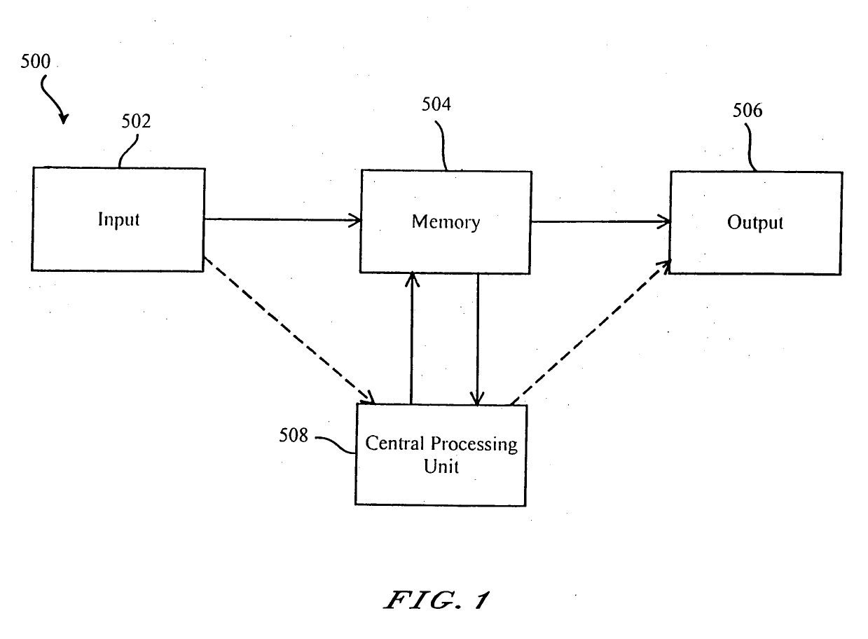

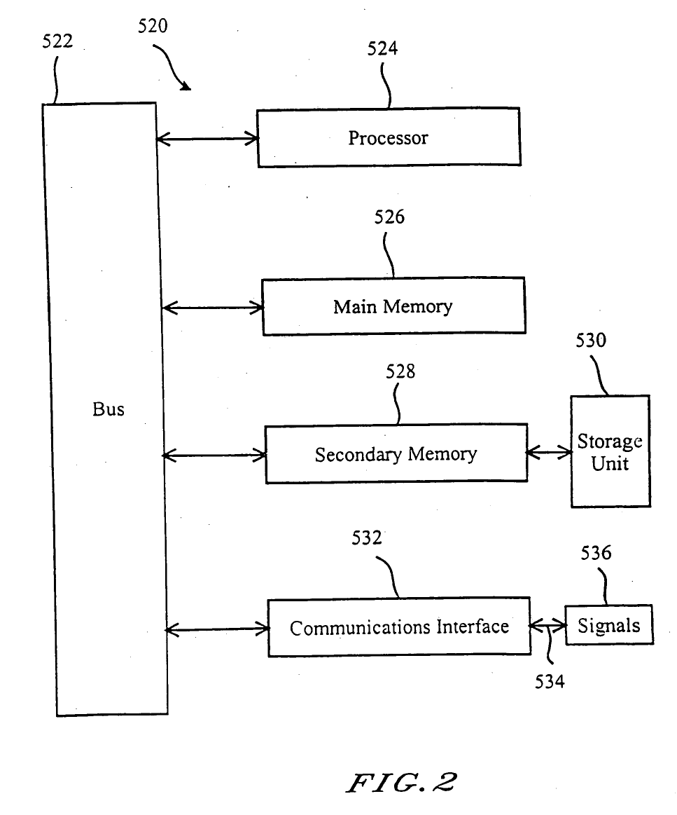

An example of software useful for implementing the schemes described herein is software capable to store, edit and maintain vehicle information as data items, such as one or more of name, address, phone number of a client/vehicle owner, vehicle identification number (“VIN”), a list of persons authorized to access the vehicle, a vehicle license tag number, insurance provider, a vehicle make, a vehicle model, date of entry into parking space. date of pick-up by owner, etc. and delegate services to be rendered as prearranged and/or as requested by the client/vehicle owner. Those of ordinary skill in the art know how to write and use such software based upon this description. This software can run on computer systems well known in the art including those shown in FIGS. 1 and 2. While the following discussion includes implementation by a plurality of computers, for example three, the invention may be accomplished using one computer. The invention contemplates the loading of software onto a computer or computers, data entry concerning necessary car maintenance and/or repair items, date of entry of the car to the facility, date of pick-up of the car, etc. Included in the invention is the use of a single network to control, maintain and/or prompt activities at a series of auto storage facilities of the invention type located in diverse areas.

FIG. 1 illustrates an exemplary portion of a generalized computer system 500 upon which portions of the invention may be implemented. For example, the configurations of the invention may each be implemented by a plurality of computers having a generalized configuration as exemplified by FIG. 1 or by a plurality of computers having configurations similar to those of FIGS. 1 and 2 described below. As noted above, a single computer may be used, if desired.

An input 502 of FIG. 1 communicates with a memory 504 and a Central Processing Unit 508. The Central Processing Unit 508 communicates with the memory 504 and an output 506. The output 506 is also in communication with the memory 504. The Central Processing Unit 508 may include an arithmetic/logic unit and a control unit in the form of hardware and/or software (not shown). One or more of inputs 502 may each be in communication with one or more memories 504 and/or Central Processing Units 508. One or more Central Processing Units 508 may be in communication with one or more outputs 506 and/or memories 504 and/or inputs 502. One or more memories 504 may be in communication with one or more inputs 502 and/or Central Processing Units 508 and/or outputs 506. Clearly, a plurality of variations of computer hardware configurations may be realized in a network of computer systems upon which portions of the invention may be implemented.

FIG. 2 illustrates an exemplary hardware configuration of a generalized computer system 520 upon which portions of the invention may be implemented. One or more processors 524 are connected to a communication bus 522. The communication bus 522 also communicates with a main memory 526, preferably a random access memory (“RAM”). A secondary memory 528 communicating with the communication bus 522 may also be included in the computer system 520. The secondary memory 520 may include, for example, a hard disk drive, a removable storage drive such as a floppy disk drive, a magnetic tape drive, an optical disk drive, a program cartridge and cartridge interface, a removable memory chip (e.g., EPROM, PROM, ROM), or any other similar storage medium. The secondary memory 528 may be in communication with a storage unit 530 such as a floppy disk, magnetic tape, optical disk, or other storage medium read by and written to by a secondary memory device. The storage unit 530 includes a computer usable storage medium for storing computer software and data.

The computer system 520 may also include a communications interface 532 in communication with the communication bus 522 for transferring software and data between the computer system 520 and external devices. Examples of communications interfaces 532 include a modem, a network interface (e.g., a network card), a communications port, a PCMCIA slot and card, and other similar interfaces. Software and data transferred via the communications interface 532 are in the form of signals 536 which are provided to the communications interface 532 via a channel 534. The signals 536 may be electronic. electromagnetic, optical or other signals capable of being received by the communications interface 532. The channel 534 may be implemented using wire, cable, fiber optics, a phone line, a cellular phone link, an RF link or other communications channels.

Computer programs are stored in main memory 526 and/or secondary memory 528. Computer programs may be received via the communications interface 532. Computer programs, when executed by the processor 524, enable the computer system 520 to perform the features of the present invention.

This invention may be conveniently implemented using one or a network of conventional general purpose digital computers and/or microprocessors programmed according to the teachings of the present specification, as will be apparent to those skilled in the computer art from reading the above descriptions regarding the figures. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium including instructions which can be used to program a computer or a plurality of networked computers to perform a process of the invention. The storage medium can include, but is not limited to, any type of disk including floppy disks, optical discs, CD-ROMs, and magneto-optical disks, ROMs, RAMs, EPROMs, EEPROMs, magnetic or optical cards, or any type of media suitable for storing electronic instructions. A preferred hardware system includes the following:

| | |
|---|---|
| Operating System | Windows 95/98 or Windows NT4 |
| CPU: | Pentium Class 166 Mhz (200 Mhz + preferred) |
| Ram: | 16 MB Win95/98, 24 MB WinNT (32 + preferred) |
| Hard Drive Space: | 100 MB before install (200 MB + preferred) |
| Backup Device: | Magnetic Tape, Optical or CD Recorder |
| Networking: | 10 MB Network adapter. Hub, and cabling |
| | NetBEUI. IPX/SPX, TCIP or equivalent protocal |
| Input: | MS Keyboard and Mouse |
| Output: | VGA video adapter and Monitor. |
| | Windows compatible printer |

### DETAILED DESCRIPTION OF THE INVENTION

As apparent from the above, in its broadest sense the present invention relates to a parking space for a car wherein ownership of the parking space includes a right to at least one car maintenance service (e.g., repair, cleaning, routine maintenance, etc.). This right may be contractual or otherwise. The maintenance services include without limitation car repair, cleaning, oil changing, lubricating, battery charging, replacing parts, filling a gas tank, painting, detailing, obtaining license plates, obtaining tax stickers, starting the engine, driving the car, transporting the car, returning a rental car, renting a rental car, selling a car, and chauffeuring. Preferably, the auto care garage, shop, organization, etc. which provides the car repair, cleaning and/or maintenance services is located adjacent to the parking space, meaning in a building next to the parking space or, if the parking space is located within a building, next to this building or in the building itself.

In one preferred embodiment an auto storage facility or structure is provided which contains a plurality of parking spaces of the invention type wherein the spaces form units in a condominium or co-op. In such instances condominium or co-op fees may be required with ownership of the parking space.

In another preferred embodiment, the at least one car maintenance service included with ownership of the parking space is provided at reduced cost, meaning at a cost below which the car maintenance operation offers services to the general public (if the car maintenance operation offers services to the general public), or at a cost which is lower than the local market value of such services (if the car maintenance operation does not provide services to the general public). In one embodiment, for example where the parking space is part of a condominium or co-op, the car maintenance service may be offered free of charge in favor of condominium or co-op fees, or included within these fees.

In another preferred embodiment, the invention parking space includes, with ownership of the parking space, a right to a certain plurality of car maintenance services and the option, as a right of ownership, to other car maintenance services provided by the car maintenance operation.

In another preferred embodiment, the at least one car maintenance service, or certain limited plurality of car maintenance services, are provided on a regular basis and without a specific request from the owner of the parking space, according to a prescribed maintenance schedule designed to maintain automobiles in good working order upon prolonged storage.

In another preferred embodiment, the invention parking spaces are located within structures constructed using the devices and methods described in, and according to the descriptions of structural elements provided in, the following U.S. patents, all incorporated herein by reference: U.S. Pat. Nos. 3,675,385, 3,608,748, 4,302,915, 4,170,310, 4,424,651, 4,664,580, 4,738,579, 4,976,580, 4,976,581, 5,037,263, 5,039,269, 5,109,642, 5,234,305 5,267,822, 5,470,185, 5,478,182, 5,749,186, 5,829,941, and 5,864,995.

Services which may be included with ownership of the invention parking space, or service which may be offered to owners of such spaces, include a valet service whereby the owner's car is picked up and/or delivered to them at their home, at the airport, etc., the provision of a cubical in the space for the storage of smaller items such as bicycles, smaller items, etc., to be stored while the car is not occupying the space, a car delivery service wherein the car is not driven when picked up or dropped off but, instead, is moved on a specialized truck designed to pick up and haul cars, twenty four hour availability to the owner's car, location of the parking space within an auto storage facility specially constructed to withstand local weather extremes such as hurricanes, tornados, earthquakes, etc., and annual service including twenty five car washes, three oil changes and a complete detailing, etc.

Another object of the invention is a condominiumized car park or cooperativeized car park where parking spaces make up units in the condo or co-op. The car park may be a lot, a structure or building (parking garage, etc.), etc.

Obviously, numerous modifications and variations of the present invention are possible in light of the above teachings. It is therefore to be understood that within the scope of the appended claims, the invention may be practiced otherwise than as specifically described herein.

Provisional application 60/079,421 is incorporated herein by reference.

1. A parking space, wherein ownership of said parking space includes a right to at least one car maintenance service.

2. The parking space of claim 1, wherein said parking space is freely alienable.

3. The parking space of claim 1, wherein ownership of said parking space includes the duty to pay a condominium or co-op fee.

4. The parking space of claim 1, wherein ownership of said parking space includes a right to at least one car maintenance service at reduced cost.

5. The parking space of claim 4, wherein said reduced cost is free.

6. The parking space of claim 1, wherein said at least one car maintenance service is at least one service selected from the group consisting of repairing, cleaning, oil changing, lubing, replacing parts, filling a gas tank, battery charging, painting, detailing, obtaining license plates, obtaining tax stickers, starting an engine, driving a car, transporting, returning a rental car, renting a rental car, selling a car and chauffeuring.

7. The parking space of claim 1, wherein the alienability of said parking space is subject to approval by a Board.

8. The parking space of claim 1, wherein said parking space is located inside an auto storage facility.

9. The parking space of claim 1, wherein said at least one car maintenance service is carried out without a specific request from the owner of said parking space.

10. The parking space of claim 1, wherein ownership of said parking space further includes the right to purchase additional car maintenance services other than said at least one car maintenance service.

11. An auto storage facility comprising a plurality of parking spaces according to claim 1.

12. The auto storage facility of claim 11, wherein said facility is a condominium and said parking spaces are units in said condominium.

13. A method for storing a car, comprising providing a parking space ownership of which includes a right to at least one car maintenance service and parking a car in said space.

14. The method according to claim 13, further comprising providing said at least one car maintenance service.

15. The method of claim 13, wherein said space is located in an auto storage facility.

16. A method for storing a car, comprising purchasing a parking space ownership of which includes a right to at least one car maintenance service and parking a car in said space.

17. A method of providing a car maintenance service, comprising offering said service to owners of parking spaces ownership of which includes a right to at least one car maintenance service and providing said service.

18. A computer program product, comprising:
a computer storage medium and a computer program code mechanism embedded in the computer storage medium, for determining a maintenance schedule for a vehicle in long term storage, the computer program code mechanism comprising:
a first computer code device configured to input vehicle information and
a second computer code device configured to process said vehicle information to determine said maintenance schedule.

19. The computer program product of claim 18, wherein said vehicle information includes at least one data item selected from the group consisting of a client name, an owner name, an address, a telephone number, a vehicle identification number, a list of persons authorized to access the vehicle, a vehicle license tag number, an insurance provider, a vehicle make, a vehicle model, and a list of routine maintenance services.

20. The computer program product of claim 19, wherein said vehicle information further includes at least one of
a list of routine maintenance services,
a list of selected maintenance services which have been selected by a client,
a list of repair services which have been selected by said client,
a date of entry of the vehicle to a storage facility, and
a date of pick-up of the vehicle from the storage facility.

21. The computer program product of claim 20, wherein said second computer code device determines said maintenance schedule by calculating at least one date on which at least one of
said list of routine maintenance services is to be provided to the vehicle,
said list of selected maintenance services which have been selected by said client is to be provided to the vehicle, and
said list of repair services which have been selected by said client is to be provided to the vehicle.

22. The computer program product of claim 21, wherein said second computer code device determines said maintenance schedule by calculating said at least one date based on at least one of
said date of entry of the vehicle to said storage facility, and
said date of pick-up of the vehicle from the storage facility.

23. An auto storage facility comprising parking spaces for cars, wherein said facility is a condominium and said spaces are units in said condominium.

24. The facility of claim 23, wherein said facility is a parking lot.

25. The facility of claim 23, wherein said facility is a building and said spaces are located within said building.
